(19) United States
(12) Patent Application Publication
(10) Pub. No.: US 2024/0331000 A1
(43) Pub. Date: Oct. 3, 2024

(54) Item Repacking Interfaces and Digital Transfer Techniques

(71) Applicant: WHATNOT INC., Marina Del Rey, CA (US)

(72) Inventor: Rob Olsthoorn, San Francisco, CA (US)

(21) Appl. No.: 18/619,819

(22) Filed: Mar. 28, 2024

Related U.S. Application Data
(60) Provisional application No. 63/492,689, filed on Mar. 28, 2023.

(51) Int. Cl. G06Q 30/0601; G06Q 20/36

(52) U.S. Cl. CPC G06Q 30/0621; G06Q 20/367

(57) ABSTRACT

Systems and methods facilitate the offering of “bundled” items including tangible items (e.g., comic books, clothing items, vintage video games, etc.) and/or digital items (e.g., non-fungible tokens (NFTs)) in a multi-user online session. Particularly, a host user offering the digital items may “bundle” a plurality of item such that the bundled plurality of items is offered to guest users, providing a representation of value of the underlying items without revealing the underlying items specifically. Larger collections of items may be split among two, three, four, five, etc., bundles, which the host user may offer successively in an online session. Contents of offered item bundles may be revealed to the host user and/or to guest users in the online session at the time at which the offering of each respective item bundle has concluded.

### CROSS-REFERENCE TO RELATED APPLICATIONS

This application claims priority to and the benefit of the filing date of U.S. Provisional Application No. 63/492,689, filed Mar. 28, 2023 and entitled “Repacking Interfaces and Digital Transfer Techniques for Non-Fungible Tokens,” the entirety of which is hereby incorporated by reference herein.

### TECHNICAL FIELD

The present disclosure relates to computing device communications, and more specifically, to system, methods, and graphical user interfaces associated with electronic distribution and transfer of tangible and/or digital items.

### BACKGROUND OF THE DISCLOSURE

In the field of computing devices such as smartphones, smart tablets, laptops, desktop computers, and the like, recent innovations have produced improvements to graphical display capabilities, touchscreen interactivity, integrated camera hardware, and data processing and transmission rates. Moreover, improvements to cellular communication networks and other wired/wireless communications networks have produced improvements to data transmission speeds, traffic handling capacity, and connection reliability. These and other technological improvements offer opportunities to make various interactive services available via computing devices, those services including, for example, auctions or other offerings of collectible items such as trading cards, toys, figurines, etc.

In particular, an existing online platform available on computing devices, including mobile computing devices, enables a seller or “host” user to offer one, two, three or more items consecutively (e.g., for auction, for direct purchase, and/or for giveaway) via a multi-user online session or (or “live event”). In the online session, the host device records a real-time video/audio stream, which prospective buyers/bidders/recipients of items (“guests”) view at their own devices in conjunction with a graphical user interface (GUI) that enables the guests to send and receive communications regarding the auction(s) (e.g., bids, comments, updates to items, etc.) in real-time. The host can use their transmitted video stream to, for example, visually feature a currently offered item and/or other items in the host's collection. At least these aspects of the online platform and sessions implemented therewith provide substantial benefits over conventional online platforms, for example by enabling hosts and guests to send and receive updated information substantially in real-time without the devices having to reload or refresh the GUI by which the devices participate in an online session, thus providing uninterrupted, social access to the online session. Further description, including system implementation, is provided in U.S. Pat. No. 11,196,577, filed Apr. 22, 2021, and U.S. patent application Ser. No. 17/958,305, filed Sep. 30, 2022, each of which is hereby incorporated by reference herein in its entirety.

Although the online sessions described above provide for the offering of various items, the present disclosure envisions still further technical improvements that may be made to the offering, presentation, and transfer of ownership of certain types of items.

### SUMMARY

The present disclosure, at a high level, provides systems and methods associated with online sessions for offering various items, including tangible items (e.g., trading cards, card packs, toys, figurines, comic books, manga, vintage video games, clothing, etc.) and/or digital items (e.g., tickets, contest/giveaway entries, opportunities to acquire items, non-fungible tokens (NFTs), etc.). More particularly, systems and methods described herein may enable a host to create one or more “bundles” from a collection comprising a multiplicity of items (e.g., bundles of three, five, or ten items from a collection of ten, 50, or 100 items). The systems and methods herein enable the host to offer each bundle during an online session, without revealing the underlying “bundled” items to the guests before concluding the offering, but still providing a description of the underlying items and/or an indication of approximate value of the underlying items (e.g., based on previous sale prices of the same or similar items through one or more online marketplaces). Upon concluding the offering, the bundle (and hence, the underlying items) are awarded to the recipient guest (e.g., the winning bidder in auction of the bundle, or buyer in an offer for direct purchase of the bundle). In embodiments, the online may implement an “unpacking” animation for the bundle, whereby the underlying items are revealed to the host and guests in the online session before proceeding to the offering of another bundle from the collection. Additionally, for some bundled digital items (e.g., NFTs), the online platform may transfer ownership of the underlying items by moving the underlying items to a digital wallet of the recipient guest.

In embodiments, a computer-implemented method is provided, the method being performed via one or more processors of one or more servers. The computer-implemented method may include (1) receiving an indication of one or more selections defining a plurality of items to be offered in an online session, the indication being received via a first client computing device associated with a host user of the online session, (2) defining one or more bundles for the selected plurality of items, each of the one or more bundles defining a respective mutually exclusive subset of the plurality of items, and the one or more bundles collectively corresponding to the selected plurality of items, (3) transmitting first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle, and/or (4) upon a conclusion of an offering of the first bundle in the online session, transmitting second communications to each of the second plurality of client computing devices in the online session, the second communications causing each of the second plurality of client computing devices to display further information identifying the subset of the plurality of items in the first bundle. The computer-implemented method may include additional, fewer, and/or alternate actions, in various embodiments.

In other embodiments, a computing system comprising one or more servers is provided. The one or more servers may include one or more processors, and one or more memories storing non-transitory computer executable instructions. The instructions, when executed via the one or more processors, may cause the computing system to (1) receive an indication of one or more selections defining a plurality of items to be offered in an online session, the indication being received via a first client computing device associated with a host user of the online session, (2) define one or more bundles for the selected plurality of items, each of the one or more bundles defining a respective mutually exclusive subset of the plurality of items, and the one or more bundles collectively corresponding to the selected plurality of items, (3) transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle, and/or (4) upon a conclusion of an offering of the first bundle in the online session, transmit second communications to each of the second plurality of client computing devices in the online session, the second communications causing each of the second plurality of client computing devices to display further information identifying the subset of the plurality of items in the first bundle. The computing system may be configured to perform additional, fewer, and/or alternate actions, in various embodiments.

In still other embodiments, one or more non-transitory computer readable media are provided. The one or more non-transitory computer readable media may store non-transitory computer executable instructions that, when executed via one or more processors, cause one or more computers (e.g., one or more servers) to (1) receive an indication of one or more selections defining a plurality of items to be offered in an online session, the indication being received via a first client computing device associated with a host user of the online session, (2) define one or more bundles for the selected plurality of items, each of the one or more bundles defining a respective mutually exclusive subset of the plurality of items, and the one or more bundles collectively corresponding to the selected plurality of items, (3) transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle, and/or (4) upon a conclusion of an offering of the first bundle in the online session, transmit second communications to each of the second plurality of client computing devices in the online session, the second communications causing each of the second plurality of client computing devices to display further information identifying the subset of the plurality of items in the first bundle. The one or more non-transitory computer readable media may include additional, fewer, and/or alternate instructions, in various embodiments.

In still yet other embodiments, a computer-implemented method is provided, the method being performed via one or more processors of a first client computing device. The computer-implemented method may include (1) receiving, via a first graphical user interface, one or more selections defining a plurality of items to be offered in an online session, (2) defining one or more bundles for the selected plurality of items, each of the one or more bundles defining a respective mutually exclusive subset of the plurality of items, and the one or more bundles collectively corresponding to the selected plurality of items, and/or (3) causing first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle. The computer-implemented method may include additional, fewer, and/or alternate actions, in various embodiments.

In other embodiments, one or more non-transitory computer readable media are provided. The one or more non-transitory computer readable media may store non-transitory computer executable instructions that, when executed via one or more processors of a first client computing device, cause the first client computing device to (1) receive, via a first graphical user interface, one or more selections defining a plurality of items to be offered in an online session, (2) define one or more bundles for the selected plurality of items, each of the one or more bundles defining a respective mutually exclusive subset of the plurality of items, and the one or more bundles collectively corresponding to the selected plurality of items, and/or (3) cause first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle. The one or more non-transitory computer readable media may include additional, fewer, and/or alternate instructions, in various embodiments.

In still other embodiments, a first client computing device is provided. The first client computing device may include one or more processors, and one or more memories storing non-transitory computer executable instructions. The instructions, when executed via the one or more processors, may cause the first client computing device to (1) receive, via a first graphical user interface, one or more selections defining a plurality of items to be offered in an online session, (2) define one or more bundles for the selected plurality of items, each of the one or more bundles defining a respective mutually exclusive subset of the plurality of items, and the one or more bundles collectively corresponding to the selected plurality of items, and/or (3) cause first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle. The first client computing device may be configured to perform additional, fewer, and/or alternate actions, in various embodiments.

In still yet other embodiments, a computer-implemented method is provided, the method being performed via one or more processors of a client computing device. The computer-implemented method may include (1) receiving, via one or more servers, first communications indicating a first bundle containing one or more items offered in an online session, (2) based upon receiving the first communications, displaying a graphical user interface associated with an offering of the first bundle of items, the graphical user interface displaying first information associated with the first bundle without identifying the one or more items in the first bundle, (3) receiving second communications via the one or more servers, the second communications indicating a conclusion of the offering of the first bundle, and/or (4) subsequent to receiving the second communications, displaying, via the graphical user interface, second information associated with the first bundle, the second information identifying the one or more items in the first bundle. The computer-implemented method may include additional, fewer, and/or alternate actions, in various embodiments.

In other embodiments, one or more non-transitory computer readable media are provided. The one or more non-transitory computer readable media may store non-transitory computer executable instructions that, when executed via one or more processors of a client computing device, cause the client computing device to (1) receive, via one or more servers, first communications indicating a first bundle containing one or more items offered in an online session, (2) based upon receiving the first communications, display a graphical user interface associated with an offering of the first bundle of items, the graphical user interface displaying first information associated with the first bundle without identifying the one or more items in the first bundle, (3) receive second communications via the one or more servers, the second communications indicating a conclusion of the offering of the first bundle, and/or (4) subsequent to receiving the second communications, display, via the graphical user interface, second information associated with the first bundle, the second information identifying the one or more items in the first bundle. The one or more non-transitory computer readable media may include additional, fewer, and/or alternate instructions, in various embodiments.

In still other embodiments, a client computing device is provided. The client computing device may include one or more processors, and one or more memories storing non-transitory computer executable instructions. The instructions, when executed via the one or more processors, may cause the client computing device to (1) receive, via one or more servers, first communications indicating a first bundle containing one or more items offered in an online session, (2) based upon receiving the first communications, display a graphical user interface associated with an offering of the first bundle of items, the graphical user interface displaying first information associated with the first bundle without identifying the one or more items in the first bundle, (3) receive second communications via the one or more servers, the second communications indicating a conclusion of the offering of the first bundle, and/or (4) subsequent to receiving the second communications, display, via the graphical user interface, second information associated with the first bundle, the second information identifying the one or more items in the first bundle. The client computing device may be configured to perform additional, fewer, and/or alternate actions, in various embodiments.

### BRIEF DESCRIPTION OF THE FIGURES

The figures described below illustrate various embodiments of the systems and methods disclosed herein. It should be understood that the figures are intended to be purely exemplary in nature. Further, wherever possible, the present disclosure refers to the reference numerals included in the following figures, in which features illustrated in multiple figures are designated with consistent reference numerals.

The patent or application file contains at least one drawing executed in color. Copies of this patent or patent application publication with color drawing(s) will be provided by the United States Patent and Trademark Office upon request and payment of the necessary fee.

There are shown in the drawings arrangements which are presently discussed, it being understood, however, that the present embodiments are not limited to the precise arrangements and instrumentalities shown, wherein:

FIG. 1 is a block diagram of an example computing environment;

FIG. 2 is a signal diagram of example communications among a server and a plurality of client computing devices;

FIG. 3A illustrates an example GUI associated with bundling items;

FIG. 3B illustrates another view of the example GUI associated with bundling items;

FIG. 4A illustrates a first view of an example host GUI for revealing bundled items;

FIG. 4B illustrates a second view of the example host GUI for revealing bundled items;

FIG. 4C illustrates a third view of the example host GUI for revealing bundled items;

FIG. 4D illustrates a fourth view of the example host GUI for revealing bundled items;

FIG. 4E illustrates a fifth view of the example host GUI for revealing bundled items;

FIG. 5A illustrates a first view of an example guest GUI for revealing bundled items;

FIG. 5B illustrates a second view of the example guest GUI for revealing bundled items;

FIG. 5C illustrates a third view of the example guest GUI for revealing bundled items;

FIG. 5D illustrates a fourth view of the example guest GUI for revealing bundled items;

FIG. 5E illustrates a fifth view of the example guest GUI for revealing bundled items;

FIG. 6 is a block diagram of an example computing device and server;

FIG. 7A is a flow diagram of an example method implemented via one or more servers;

FIG. 7B is a flow diagram of an example method implemented via a client computing device; and

FIG. 7C is a flow diagram of another example method implemented via a client computing device.

One skilled in the art will readily recognize from the following discussion that alternate embodiments of the structures and methods illustrated herein may be employed without departing from the principles of the invention(s) described herein.

### DETAILED DESCRIPTION

Embodiments of the present disclosure relate to computing systems and methods that, broadly speaking, utilize a software application implemented at electronic computing devices and/or other electronic computing devices, the application facilitating multi-user online sessions (or “live events”) that include auctions, direct purchases, and/or giveaways of collectible items. Such items can include, but are not limited to trading cards, card packs, toys, figurines, comic books, manga, vintage video games, clothing, tickets, contest/giveaway entries, opportunities to acquire items, etc. Additionally, some embodiments of the present disclosure provide improved systems and methods relating to online sessions for offering digital items such as non-fungible tokens (NFTs), the improved systems and methods being implemented via an online platform in communication with a host device and/or guest device(s) associated with the online session(s).

In embodiments of the present disclosure, a host of an online session (e.g., one or more current or futures sessions conducted via the online platform described herein) may navigate to an item inventory of the host, which may include a collection of items that the host intends to offer during the online session (e.g., offer for auction, direct purchase, or giveaway). The collection of items in the host item inventory may, for example, include items from an issued series of related items (e.g., corresponding to a same project, creator, publisher, etc.), and/or may include entirely different, unrelated items. The collection of items in the host item inventory may, for example, include ten, twenty, 50, 100, 500, or 1000 items. Examples of user interfaces, systems, and methods associated with selecting items for offering in an online session are provided in U.S. Pat. No. 11,196,577, filed Apr. 22, 2021, and U.S. patent application Ser. No. 17/958,305 filed Sep. 30, 2022.

Upon selecting the items to be offered in an online session (e.g., one or more current or future sessions), the online platform may create one or more “bundles” from the selected collection of items, each of the one or more bundles including at least a subset of the selected collection to be offered via an online session implemented via the online platform. In some embodiments, forming the one or more bundles includes “splitting” the collection into two, three, four or more bundles comprising mutually exclusive portions of the selected collection. In these scenarios, the splitting of the bundles may be randomized and the identities of the underlying items comprising each respective bundle may be hidden (from the host and from guests) until the respective bundle has been offered and awarded to a particular guest in an online session (e.g., a buyer, an auction winner, or a giveaway winner). Thus, guests eventually viewing or soliciting the bundled items during an online session do not view or solicit the individual items, but rather, view or solicit the bundle as a whole with the understanding that the contents of the bundle are awarded to the purchaser, highest bidder, giveaway winner, etc. upon the conclusion of the offering.

In conventional online platforms, users offering items in online sales or auctions set price parameters associated with the sale/auction (e.g., a direct purchase price, or a starting price point for an auction). However, in view of the fact that contents each of multiple item bundles may be obscured to the host offering the bundles, the present disclosure proposes techniques via which the online platform may determine and display sale/auction price parameters for each respective bundle based on the respective contents. The online platform may, for example, determine price values for any respective bundle based upon past sales/auctions of the same and/or similar items to those in the respective bundle and/or other bundles in the selected collection (e.g., based upon lowest, highest, and/or average previous sale values, on the same online platform and/or sourced from other item sales/distribution platforms). In some embodiments, the online platform may set or suggest price parameters for an offering of a respective bundle (e.g., a direct purchase price or starting bid amount) based on the determined price value(s) for the respective bundle. Additionally or alternatively, during an online session, GUIs of the online session may display indications of the price values to guests viewing or soliciting each respective bundle during the offering of the bundle, such that guests are provided an estimated value or value range for the bundle contents without revealing the bundle contents during the offering. Moreover, in some embodiments, the splitting of a collection into multiple bundles may be based at least partly upon the determinations of price value(s) for the collection, e.g., to split the collection into bundles having similar approximate value to each other, or at least to limit the variation of value among bundles.

Still additionally or alternatively, in embodiments of the present disclosure, the online platform may provide for automatic transfer of ownership of digital items from a host of an online session to a guest to whom the one or more items are to be awarded at the end of the offering of the one or more items (e.g., transferring digital ownership of a group of bundled NFTs from the host to an auction winner, direct purchaser, etc.). In embodiments, the online platform may store user information associated with the host of the online session, the host user information including an indication of one or more digital wallets belonging to the host, the digital wallet(s) identifying the host as the owner of the collection of items (e.g., an NFT wallet). The online platform may cause ownership of the collection of items to be transferred to one or more “intermediary” digital wallets of the online platform upon the host designating the collection of items for inclusion in the online session(s), to facilitate later transfer of the items to respective guests to whom the items are awarded. While the items are held in the intermediary wallet, the online platform may store a record of association of the items with the owner wallet, effectively tracking the host as the “functional owner” of the items until the items are awarded to respective guests in respective offerings during the online session. Using the stored record, the online platform may direct any communications, benefits, gifts, etc. associated with ownership of the items to the host who is still considered the functional owner until completion of the offerings.

Unless stated or demonstrated otherwise, it should be appreciated that many of the systems and methods of the present disclosure may be applied to various different types of items, including digital items (e.g., a collection of NFTs) and/or tangible items (e.g., a collection of trading cards, card packs, toys, figurines, comic books, manga, vintage video games, etc.). In any case, price values of bundles of items may, for example, be determined based upon obtained records of previous sale/auction prices of same and/or similar items via one or more suitable marketplaces (e.g., via the same online platform and/or different online marketplaces).

As described herein, an “item offering” may be any form of transaction (e.g., an auction, a direct purchase, a giveaway, etc.) of an item from the host to the guest. Although items may be offered and/or transacted during the online session of the present disclosure, “item offerings” may extend to either before, after, or entirely disconnected from online sessions. For example, an item may be available for direct purchase on an online profile page of the host while no online session is offered (e.g., advertised on the host profile page via one or more images or videos displayed on or otherwise accessible via the host profile page).

### Exemplary Computing Environment

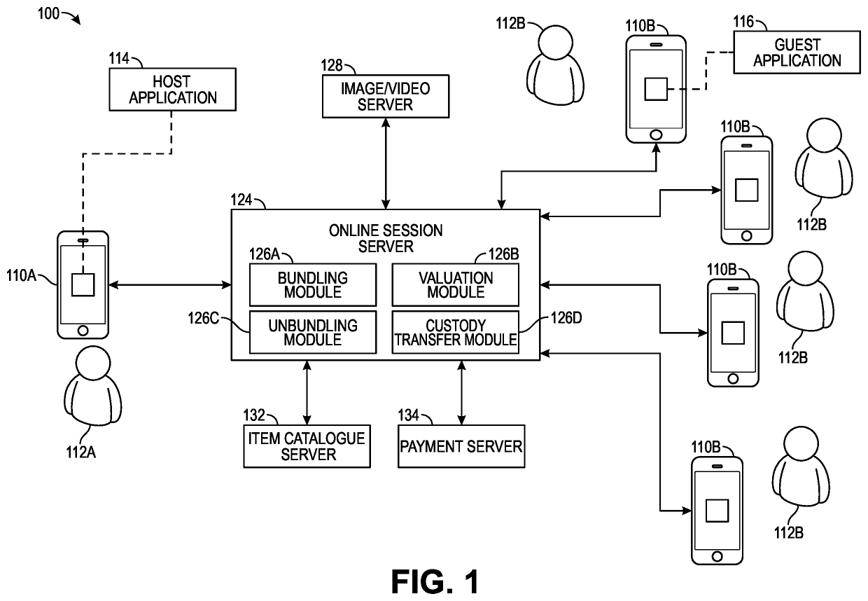

FIG. 1 illustrates a block diagram of an example computing environment 100 via which techniques of the present disclosure may be implemented. In particular, elements of the computing environment 100 may provide the services and features described herein, e.g., implementing online sessions including offerings of bundled tangible items and/or digital items (e.g., NFTs). Although various components of the example computing environment 100 will be described below, it should be understood that additional, fewer, and/or alternate components may be envisioned in various embodiments, without necessarily deviating from the techniques described herein.

The computing environment includes a first computing device 110a associated with a first user 112a, and one or more second computing devices 110b associated with respective ones of one or more second users 112b. Computing devices 110a and 110b may include, for example, smartphones, smart tablets, laptops, desktop computers, smart wearable devices, other suitable devices, and/or some combination thereof.

In the example environment 100, the first user 112a represents a “seller” or “host” associated with an online session facilitated via the online platform described herein, e.g., a person or entity offering one or more items (or, in embodiments of the present disclosure, bundled items) using the services and features of the present disclosure. Accordingly, the first computing device 110a is generally referred to herein as a host device 110a. The second users 112b in this example represent prospective buyers or recipients (or “guests”) participating in the online session, e.g., to bid upon or purchase items or to use other social functionalities enabled by the online session. Accordingly, the computing devices 110b are referred to herein as guest devices 110b.

Each of the computing devices 110a and 110b may respectively comprise one or more computer processors and one or more non-transitory computer memories storing instructions that, when executed via the one or more processors, cause the device 110a or 110b to perform the actions attributed to the device 110a or 110b in the present disclosure. In the case of the host device 110a, the one or more non-transitory memories may store one or more software applications 114 (“host application”) including one or more sets of non-transitory computer executable instructions that, when executed via the one or more processors, cause the host device 110a to perform actions described herein. Similarly, the one or more memories of each guest device 110b may store one or more software applications 116 (“guest application”) including one or more sets of non-transitory computer executable instructions that, when executed via the one or more processors of the guest device 110b, cause the guest device 110b to perform actions described herein. Although host application 114 and guest application 116 are illustrated as separate blocks in FIG. 1, it should be understood that applications 114 and 116 may represent separate aspects of the same one or more applications (e.g., a single application stored and executed both at devices 110a and 110b, in which each user 112a or 112b may alternatively operate as a host or guest using the single application). Each of the host device 110a and guest devices 110b may comprise one or more application programming interfaces (APIs) operable for example to (1) generate and display GUIs, (2) capture or otherwise obtain still images and/or videos, (3) display images, videos, item information, and/or other information described herein, (4) communicate with one or more servers (e.g., to receive real-time item information and/or communicate bids/purchases placed via the each device), and/or perform other actions described herein.

The host device 110a (and, in some instances, the guest devices 110b) may comprise one or more camera devices, which may for example capture still images and/or video content to be included as part of an online session (e.g., the host device 110a may capture and transmit a real-time video stream to be transmitted to and displayed at guest devices 110b while each guest device 110b participates in the online session). Additionally, in some embodiments, the host device 110a (and in some instances, the guest devices 110b) includes one or more microphones and/or speakers, which may capture, transmit, and/or play audio (e.g., accompanying audio in a video stream). The one or more camera devices, microphones, and/or speakers may include integrated devices (e.g., a camera, microphone, or speaker natively included in a computing device 110a/110b) and/or devices otherwise communicatively tethered to the host device 110a or guest device 110b (e.g., a peripheral webcam, speaker, or microphone connected wired or wirelessly to the computing device). Additionally, each of the host device 110a and guest devices 110b may include one or more interactive I/O units (e.g., touchscreens, touchpads, keyboard, etc.) enabling navigation of graphical user interfaces, viewing of images and/or videos in the context of a real-time video stream, and/or interactive functionalities described herein.

An online session server 124 (i.e., one or more servers) may generally host an online platform that facilitates/enables communications among devices 110a and 110b in association with online sessions for offering items using the techniques of the present disclosure. Accordingly, the server 124 may store various information associated with implementation of online sessions and the users therein, including for example information relating to scheduled sessions, past sessions, items, item queues, bundled items, user profiles, user devices configuration information, session metrics/analytics, etc. The server 124 may store and implement logic relating to offerings of items via the online session(s). The server 124 may include one or more processors and one or more non-transitory computer readable memories storing instructions that, when executed via the one or more processors, cause the online session server 124 to perform the actions described herein. In the one or more non-transitory memories of the online session server 124 may include a bundling module 126a, an item/bundle valuation module 126b, an unbundling module 126c, and/or a digital custody transfer module 126d.

The bundling module 126a may generally store or comprise instructions corresponding to designation of a collection of items to be offered in online sessions via one or more bundles via techniques of the present disclosure. A host of an online session may, before or during the online session, designate items from an item inventory of the host (e.g., the host may select a collection of items per se, or may select each item individually). Upon designation of the items from an item inventory of the host, the bundling module 126a may select assign the selected items to one or more bundles comprising mutually exclusive subsets of the collection of items. Collectively, the one or more bundles correspond to the entirety of the selected collection of items. In embodiments, the bundling module 126a assigns items to bundles randomly. In some embodiments, the bundling module 126a may assign items to bundles based on metadata associated with the respective items (e.g., to favor an even distribution of items and/or bundles by item type, value, and/or other parameters). In any event, the identities of the underlying items in each bundle may be obscured from the host and/or guests from the time of the bundling to at least the time at which the bundle is awarded to a guest in an online session.

The item/bundle valuation module 126b may generally store or comprise instructions corresponding to determination of price values corresponding to items selected by a host. Generally speaking, the valuation module 126b may determine price values for items based upon sales/auctions of the same or similar items via one or more online marketplaces. For example, in implementations involving NFTs, for any given NFT that is part of a given NFT collection, the valuation module 126b may obtain information indicating past sale/auction values of the same NFT, and/or other NFTs from the same NFT collection (e.g., via AtomicHub®, OpenSea®, Rarible®, NBA Top Shot®, etc.). For other types of items (e.g., physical trading cards, figurines, clothing items, etc.), the valuation module 126b may obtain information indicating past sale/auction values of the same or similar items (e.g., items in a same collection) via one or more other online marketplaces.

For a bundle comprising two or more items, the valuation module 126b may use the past sale/auction values to determine a number of price values to be associated with the bundle. For example, the valuation module 126b may determine a combined average price value corresponding to a sum of average sale/auction values of each respective item in the bundle (and/or average sale/auction values of similar items for each respective item in the bundle). As another example, the valuation module 126b may determine a combined floor price value corresponding to a sum of the of the lowest obtained sale/auction values of each respective item in the bundle (and/or lowest sale/auction values of similar items for each respective item in the bundle). As still another example, the valuation module 126b may determine a combined ceiling price value corresponding to a sum of the of the highest obtained sale/auction values of each respective item in the bundle (and/or highest sale/auction values of similar items for each respective item in the bundle). As still yet another example, the valuation module 126b may determine an average, lowest, or highest value across all bundles in the collection (e.g., average floor value among all bundles, average ceiling value among all bundles, etc.). Still additional or alternative valuation techniques are possible in various embodiments. Thus, the valuation module 126b may provide a number of ways of representing value of the underlying items contained in a bundle, without revealing the precise underlying contents before the bundle is offered and awarded in an online session.

In embodiments, the valuation module 126b may operate together with the bundling module 126a in the distribution of items among two or more bundles. For example, the bundling module 126a may assign items of a collection into two or more bundles based upon price values determined via the valuation module 126b (e.g., to provide an even or quasi-even distribution of value among the respective sets of items in two or more bundles, using any of the valuation techniques described herein).

The unbundling module 126c may generally store or comprise instructions corresponding to revealing (“unbundling”) the respective contents of bundles of items once each respective bundle has been awarded in an online session using the online platform of the present disclosure (e.g., awarded via auction, direct purchase, or giveaway). In embodiments, the unbundling module 126c may cause bundle contents to be automatically revealed once the bundle has been awarded to a guest, or may cause an option to be presented to the guest to cause the bundle contents to be revealed (or, alternatively, to leave the bundle for unbundling or “opening” at a later time). In the event that the bundle is revealed immediately following the offering (or otherwise during the online session), the unbundling module 126c may cause an animation to be displayed to the host and guests via one or more GUIs of the online session, with the bundle contents being revealed to the host and/or guests via the animation. Examples of GUIs associated with revealing bundled items will be provided in subsequent portions of the present disclosure.

The digital custody transfer module 126d may generally store or comprise instructions corresponding to digital transfer of ownership of items (e.g., each digital item in a bundle) between a host and a guest to whom the items are awarded in an online session. In embodiments wherein the items include NFTs, the digital custody transfer module 126d may cause the NFTs to be transferred host to an intermediary NFT wallet of the online platform from an NFT wallet associated with the host's profile upon the host designating the NFTs for inclusion in an offering in an online session. Upon conclusion of the offering, the digital custody transfer module 126d may cause the NFTs to be transferred from the intermediary wallet to an NFT wallet associated with the awarded guest's profile. While the NFTs are held in the intermediary wallet, the online platform may store a record of association of the NFTs with the owner wallet, effectively tracking the host as the “functional owner” of the NFTs until the NFTs are awarded to respective guests in respective offerings during the online session. Using the stored record, the online platform may direct any communications, benefits, gifts, etc. associated with ownership of the NFTs to the host who is still considered the functional owner until completion of the offerings.

The online session server 124 may communicate with still additional servers to facilitate other functions described herein. For example, an image/video server 128 may facilitate operations of the online session server 124 by facilitating provision of images and/or a video stream from the host device 110a to the guest devices 110b. Additionally or alternatively, an item catalogue server 132 may store a listing of known items, from among which host users 112a may designate items to be included for purchase, auction, giveaway, etc. in an online session. Based on corresponding item information stored at the item catalogue server 132, designated items may be populated with various metadata for the item (e.g., size, value, description, shipping information etc.) without the host user 112a needing to manually enter the item information. Still additionally or alternatively, a payment server 134 may store and process payment information relating to host users 112a and/or guest users 112b who are to acquire items via the systems and methods described herein. Although each of the line session server 124, image/video server 128, item catalogue server 132, and payment server 134 are described in singular herein, it should be understood that each of the one or more servers 124, 128, 132, and 134 may respectively comprise one or more server devices, with functions thereof being distributed among the one or more servers.

Arrows in FIG. 1 represent signal communications exchanged among the elements of the computing environment 100. Elements of the computing environment 100 may communicate via any suitable one or more communications networks (e.g., the Internet, a wired or wireless local area network (LAN), etc.). Elements of the computing environment 100 may communicate of via any suitable one or more communication protocols, including for example a cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of respective elements of the computing environment 100.

Generally, each of the image/video server 128, the item catalogue server 132, and the payment servers 134 may respectively comprise one or more processors and one or more non-transitory memories storing computer executable instructions that, when executed by the one or more processors, cause the one or more servers to perform actions described herein. Although arrows in FIG. 1 connect the computing devices 110a and 110b to the one or more servers 128, 132, and 134 by way of the online session server 124, it should be noted that in some embodiments, the one or more servers 128, 132, and/or 134 may exchange communications directly with the computing devices 110a and 110b. Furthermore, although the one or more servers 124, 128, 132, and 134 are illustrated in FIG. 1 as separate elements, it should be understood that functions of the one or more servers 124, 128, 132 and 134 may be combined in various manners, in some embodiments. For example, in some embodiments, the online session server 124 is configured to also perform at least some of the functions of the image/video server 128, the item catalogue server 132, and/or the payment server 134.

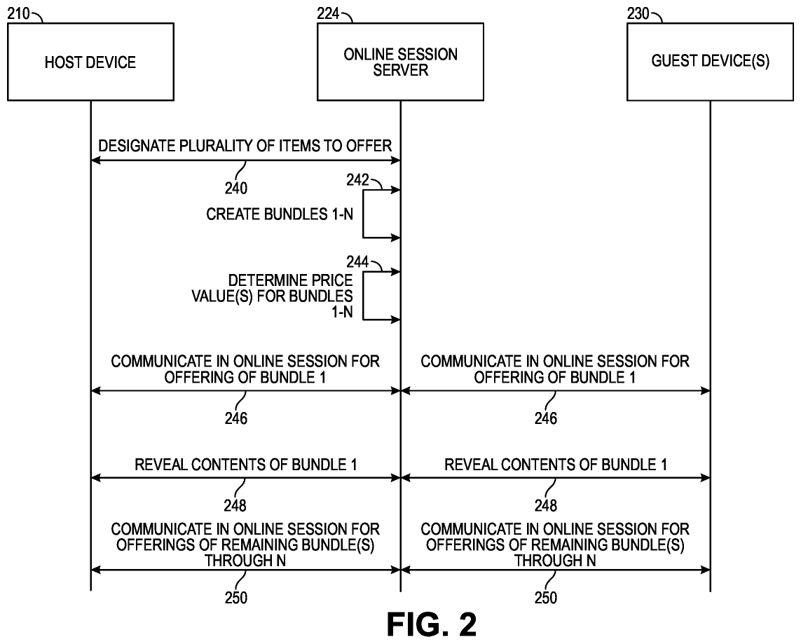

Subsequent portions of the present disclosure, with reference to FIGS. 2, 3A, 3B, 4A-4E, 5A-5E, 6, and 7A-7C provide examples of communications, GUIs, devices and computer-implemented methods associated with implementation of the functionalities described herein. In various embodiments, described communications, GUIs, actions, etc. may be implemented by suitable components of the computing environment 100 described above. Where interactive GUIs at a computing device are described, interactions with the interactive GUIs may occur, for example, via touchscreen interactions, voice commands, and/or other suitable forms of user input at devices 110a and/or 110b. Described logic, communications, and functionalities may be implemented via the online session server 124 (including the modules 126a-126d therein) and/or via the other servers of FIG. 1 in direct or indirect communication with the devices 110a and 110b.

### Exemplary Communications Among Server and Host/Guest Devices

FIG. 2 illustrates a signal diagram including communications and other actions that may take place among a host device 210, an online session server 224, and guest devices 230 (i.e., one or more guest devices). The host device 210 may, for example, correspond to a host device 110a of FIG. 1. Likewise, the guest device(s) 210 may, for example, correspond to one or more guest devices 110b of FIG. 1. The online session server 224 may, for example, correspond to the online session server 124 and/or one or more other servers facilitating the online platform as described with respect to FIG. 1. It should be appreciated that the order of actions may differ from that illustrated in FIG. 2 in various embodiments, at least some of which will be described herein.

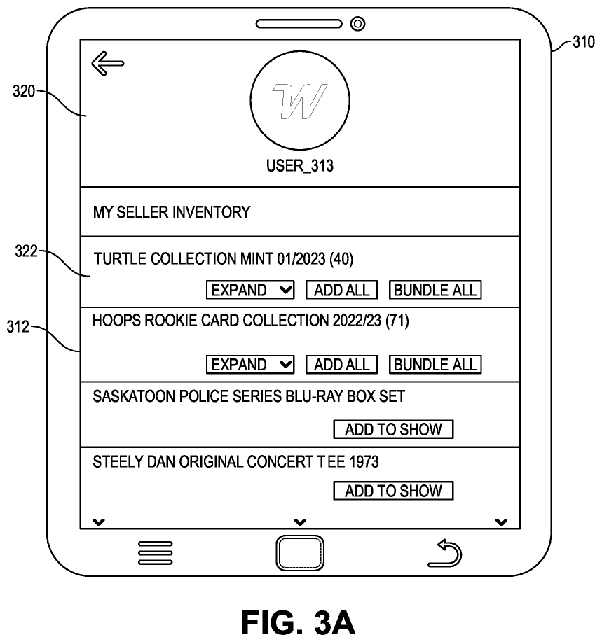

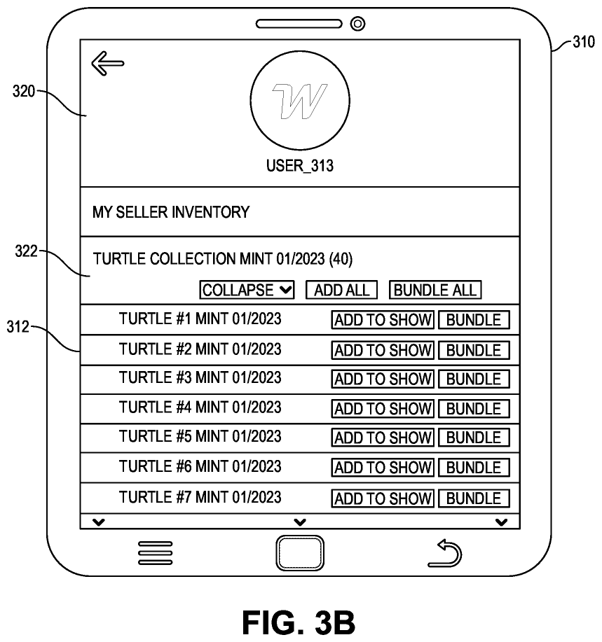

The host device 210 (e.g., a user of the host device 210) may designate a plurality of items to be offered in one or more online sessions using the online platform (240). The plurality of items may, for example, be a collection of items such as a collection of NFTs, trading cards, figurines, etc. A user of the host device 210 may designate the plurality of items via interactions with one or more GUIs presented at the host device 210. Examples of GUIs for designating a plurality of items to offer will be described with respect to FIGS. 3A and 3B.

Upon designation of the items at action 240, the online session server 224 may create one or more bundles from the designated plurality of items by assigning each respective one of the plurality of items to one of one or more bundles 1−n (242). In some scenarios, only one bundle may be created (e.g., a collection of ten items may be assigned to just one bundle, which may be offered as such and thus still provide the aspect of obscuring the underlying items). In other scenarios, the plurality of items may be assigned to a different number of bundles n (e.g., two, three, four, five, ten, twenty, 50, 100, etc.).

The server 224 may assign items to bundles entirely randomly, or partially randomly subject to one or more criteria (e.g., random selection except for conditions based upon item type, item value, etc.). Alternatively, in some embodiments, the host device 210 (e.g., the user thereof) may designate items for assignment to respective bundles, or at least designate conditions according to which the server 224 assigns items to bundles (e.g., distribution of items among bundles according to item type, item value, and/or other parameters). In some embodiments, the host device 210 may designate the total number of bundles to be created from the designated plurality of items, or the number of items to be assigned to each bundle. In some embodiments, bundles may be equal or approximately equal in size where possible. In other embodiments, bundles may differ in size (e.g., a same collection of 50 items may include bundles of three, five, seven, ten, etc.). The server 224 may store information associated with bundled items for future retrieval. For example, the host device 210 may designate items before an online session during which the items are to be offered, and the server 224 may retrieve and cause bundles to be offered. Alternatively, the server 224 may cause a listing of bundles to be presented to the host device 210 during the online session to enable the host device 210 to choose which of the bundles are to be offered.

The online session server 224 may determine respective price values for each of the bundles 1−n (244). Determined price values for any respective bundle may include, for example, summated highest, lowest, or average past sale prices for the items in the respective bundle (and/or for comparable items to those in the respective bundle). Other price values may be envisioned, for example according to techniques discussed elsewhere in the present disclosure. In some embodiments, additionally or alternatively to the online session server 224 determining price values for the bundle, the host device 210 may set a sale/auction price for the bundle (e.g., the host device 210 may set a price, whereas another price value(s) determined via the server 224 may or may not be presented alongside the host's sale/auction price during the offering of the bundle in an online session).

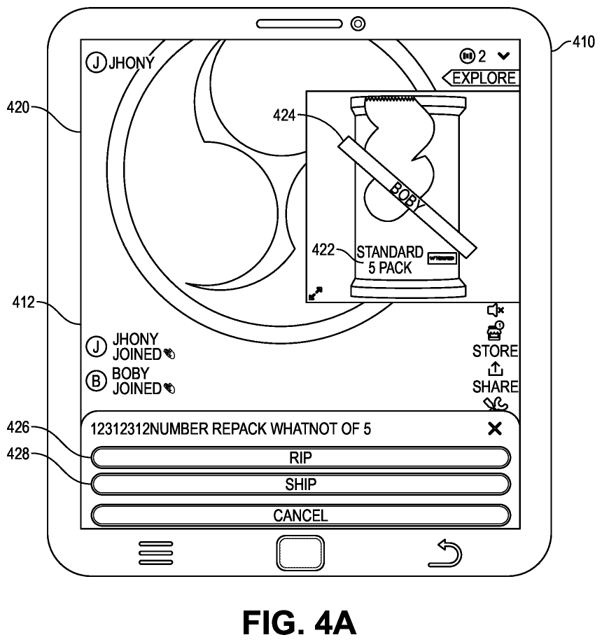

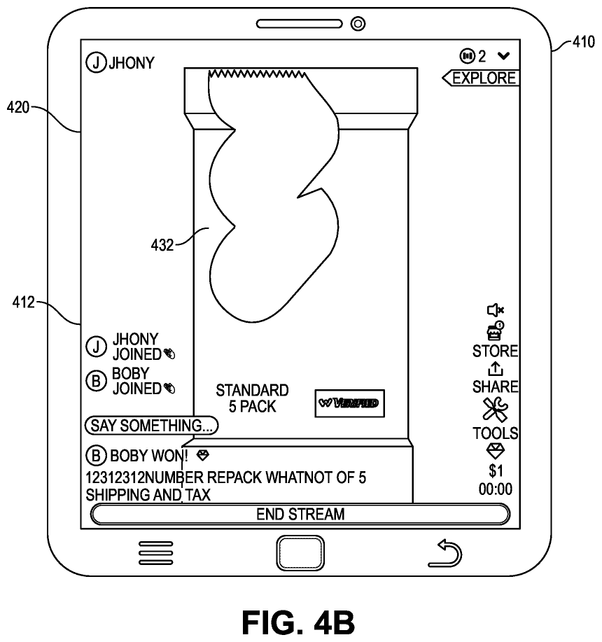

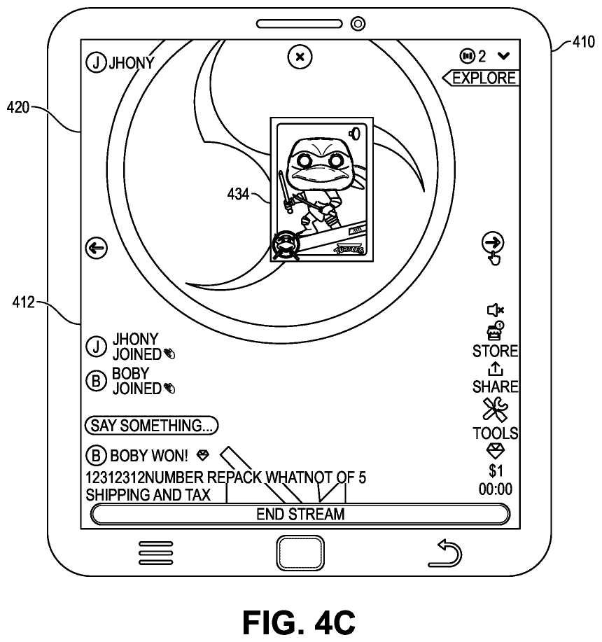

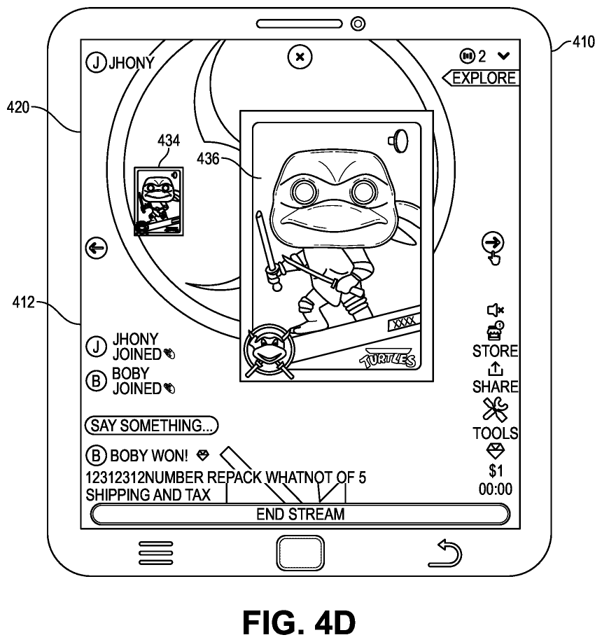

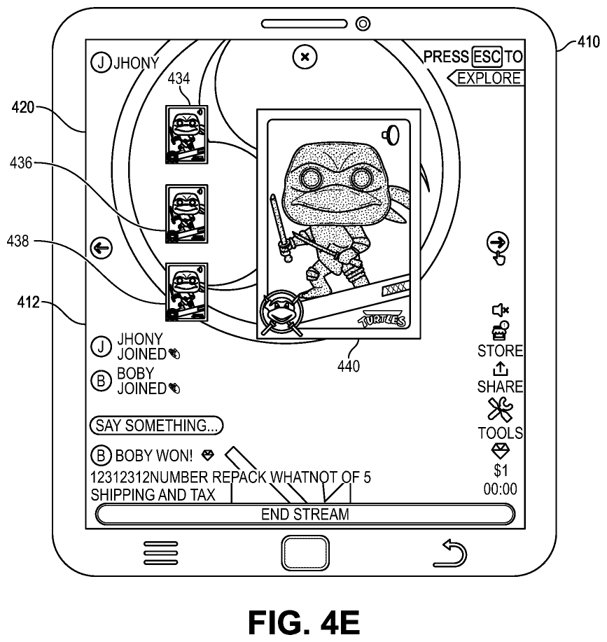

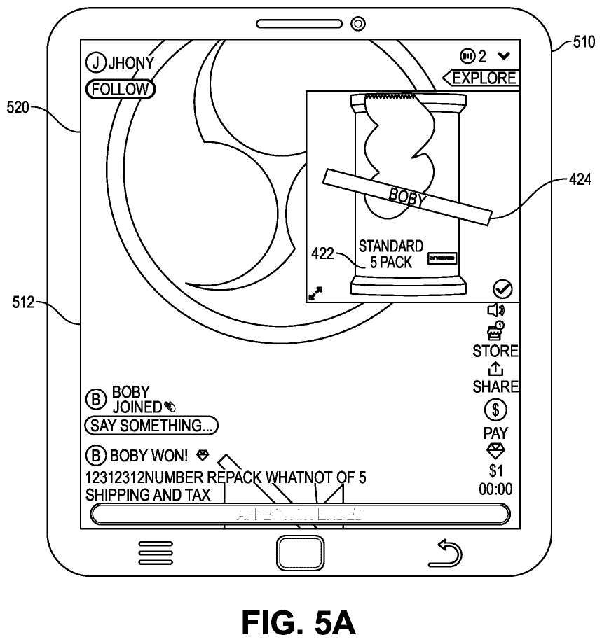

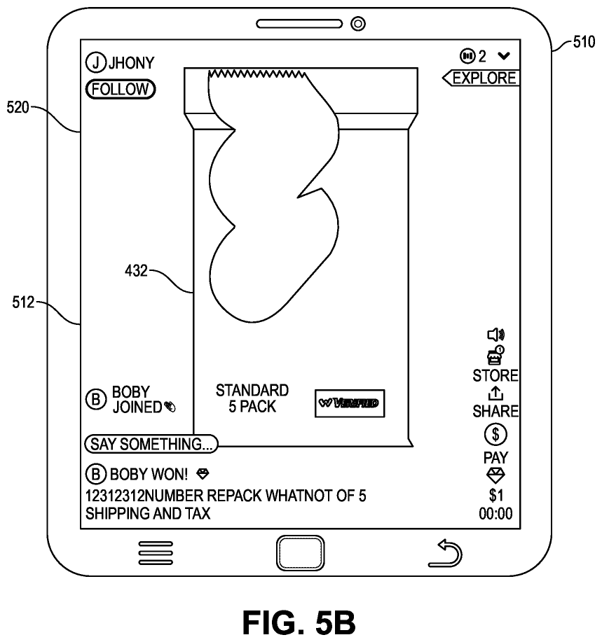

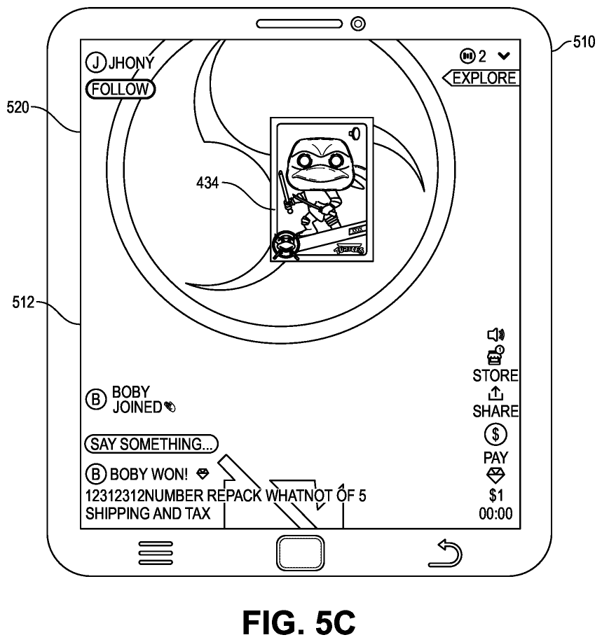

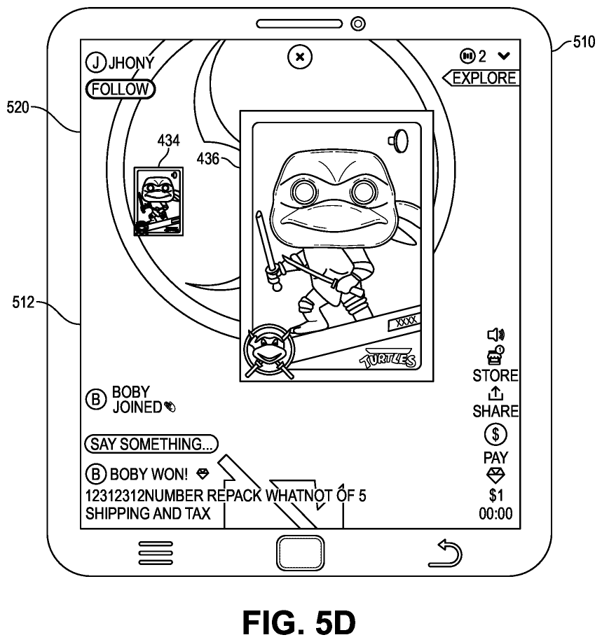

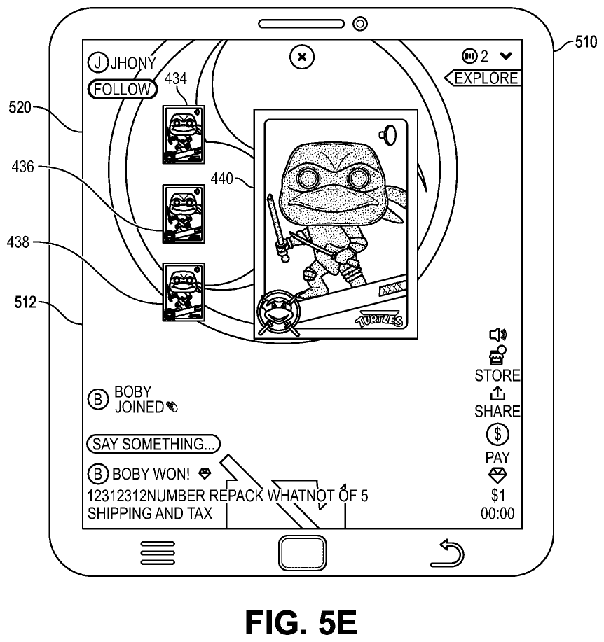

During an online session (e.g., as described for example in U.S. Pat. No. 11,196,577, filed Apr. 22, 2021), the server 224 may engage in unidirectional and/or bidirectional communications (246) with the host device 210 and with each of the one or more guest devices 230 (e.g., five guest devices, or ten, twenty, 50, 100, 500, or however may guest devices are currently participating in the online session). Generally speaking, the communications associated with the online session relate to the sequential offering of items by the host to the guests. The items offered in the online session may include one or more of the bundles 1−n, information regarding which may be distributed to the host device 210 and guest devices 230 in accordance with the techniques of the present disclosure. Communications exchanged via action(s) 246 may include item information, sale/auction timers, real-time video from the host device 210, comments from other guests, metadata relating to the online session, and/or other session information such as that described and illustrated in U.S. Pat. No. 11,196,577). Communications exchanged in association with the online session may causes the host device 210 and/or guest devices 230 to display one or more graphical user interfaces (GUIs) to present the information to respective device users. Additional examples of GUIs associated with an online session will be discussed with respect to FIGS. 4A-4E and 5A-5E.

Upon conclusion of the offering of a first bundle (e.g., upon purchase, giveaway, or closing of auction of a bundle “1”), the online session server 224 may cause the contents of the bundle to be revealed to the host device 210 and/or guest devices 230 (248). Alternatively, in some embodiments, the online session server 224 may cause an option to be presented at the particular guest device to which the bundle was awarded, to enable the corresponding user to choose whether to immediately reveal the bundle contents or to instead send the bundle to the guest's item inventory to be revealed at a later time. Examples of GUIs corresponding to revealing bundle contents will be discussed with respect to FIGS. 4A-4E and 5A-5E.

Subsequent to the conclusion of the offering of the first bundle, the online session may proceed similarly with other bundles created from among the plurality of items designated by the host device 210 (250). For example, the online session may continue while the host consecutively offers each respective one of the created bundles 1−n (and/or while other items are offered in the same online session). Accordingly, communications at action(s) 250 may include analogous actions to those discussed with respect to actions 246 and 248.

### Exemplary Graphical User Interfaces (GUIS)

Embodiments of the present disclosure will be described with respect to FIGS. 3A, 3B, 4A-4E, and 5A-5E, which illustrate example graphical user interfaces (GUIs) that may be displayed at host and/or guest devices in association with online sessions implemented by the online platform of the present disclosure. Generally speaking, the GUIs described with respect to these figures may be implemented at client computing devices of host users and/or guest users in online sessions (e.g., smartphones, tablets, laptop computers, desktop computers, etc.). The GUIs may be implemented via communication with one or more servers implementing the online platform of the present disclosure. GUIs of these figures may execute at respective client computing devices based upon execution of non-transitory instructions stored at one or more computer memories of the respective client computing devices (e.g., stored as a host application 114 and/or a guest application 116 as described with respect to FIG. 1). User interaction with the GUIs described herein may be performed, for example, via touchscreen interactions, mouse and keyboard interactions, and/or various other known techniques of user interaction. The GUIs of the following figures are only exemplary in nature, in it should be appreciate that various alternations may be envisioned, for example based upon techniques discussed in other portions of the present disclosure.

FIG. 3A illustrates an example GUI 320 executing at a display 312 (e.g., touchscreen) of a client computing device 310. Particularly, the client computing device 310 is a computing device of a host user adding items to an online session using the online platform of the present disclosure (e.g., adding items for offering in a live online session, or adding items to be offered in a future online session). The GUI 320 presents an item inventory corresponding the host user, listing respective entries for each of a plurality of items and/or item collections in the host inventory. In particular, the host inventory includes an entry 322 for a collection in the host inventory (e.g., a collection of turtle trading cards). The entry 322 presents a first option to expand the collection, i.e., to reveal on the GUI 320 the underlying items in the collection. The entry 322 presents a second “add all” option that the user of the device 310 may select to add each of the collection of items for offering individually in an online session (i.e., without the bundling techniques of the present description). The entry 322 presents a third option 322 that the user may select to cause the entire collection of items to be added for offering as one or more bundles (e.g., one, two, three, four, five, ten, or more bundles, of same or varying sizes).

FIG. 3B illustrates a modification to the GUI 320 of FIG. 3A that may be displayed at the device 320, e.g., in response to selection of the “expand” option from FIG. 3A. The GUI 320 as illustrated in FIG. 3B lists the individual items in the selected collection of items, which the user may navigate for example via touchscreen interactions, mouse scrolling, and/or other suitable user interface interactions. The GUI 320 as illustrated in FIG. 3B presents, for each individual item in the item collection, a first option to add the respective items to an online session (or “show”) for offering individually, and a second option to add the respective item to one of one or more bundles to be created for the item collection.

Various modifications to the GUI 320 of FIGS. 3A and 3B may be envisioned. Such modifications may include, but are not necessarily limited to, modifications to incorporate user interface elements or functionalities described in U.S. Pat. No. 11,196,577, filed Apr. 22, 2021, and/or U.S. patent application Ser. No. 17/958,305 filed Sep. 30, 2022. Particularly, the GUI 320 may incorporate various aspects of navigating a user item inventory as discussed in either of the aforementioned documents.

Moving to FIGS. 4A-4E, a client computing device 410 includes a display 412 (e.g., a touchscreen) presenting a GUI 420 associated with offering items in an online session (e.g., offering individual items or bundled sets of items). Generally speaking, the GUI 420 as illustrated in FIG. 4A-4E is associated with ending an offering of a bundle and revealing the bundle contents, from the perspective of a host user (i.e., from the device of the host user in the online session). Accordingly, the client computing device 410 may be any suitable computing device of a host user in the online session (“host device,” e.g., computing device 110a of FIG. 1, and/or computing device 310 of FIGS. 3A and 3B).

Beginning with FIG. 4A, the GUI 420 illustrates a view of the online session at the end of an offering of a bundle (e.g., at closing of an auction, at conclusion of a giveaway, or upon direct purchase of an offered item by one of one or more guests in the online session). The GUI 420 displays various real-time information associated with the online session, including an identification of the host, an identification of the online session, a real-time viewer count, a volume control, and a real-time activity feed (e.g., displaying comments, interactions, and recent entries to the online session). Particularly, though, the GUI 420 in FIG. 4A displays a representation of the bundle 422, and an indicator of the guest user 424 to whom the bundle was awarded. Notably, the bundle representation 422 provides a general indication of the bundle contents without revealing the individual underlying items in the bundle (e.g., displaying “Standard 5 Pack,” without actually identifying the underlying items). In various embodiments, the GUI 420 may display additional or alternative information to that illustrated in FIG. 4A, including for example any one or more price values for the bundle 422 as discussed in the present disclosure.

Still referring to FIG. 4A, the GUI 420 provides a “Rip” option 426 that the host user may select to cause the contents of the bundle 426 to be immediately revealed to the host and to a plurality of guests in the online session. Alternatively, the host user may select a “Ship” option 428 to cause the bundle (i.e., the underlying contents) to be directed to an inventory of the awarded guest without revealing the bundle contents in the online session. In some embodiments, selection of the Ship option 428 allows the awarded guest to determine whether the bundle contents are to be revealed publicly in the online session (e.g., via interactions at the awarded guest's device).

Subsequent FIGS. 4B-4E represent still images from an exemplary animation that may be displayed to the host device 410 and at guest devices participating in the online session. Generally speaking, the animation serves to reveal the underlying items in the bundle 422 from FIG. 4A, and may be displayed, for example, in response to the host user or the awarded guest user selecting an option to reveal the bundle contents in the online session (e.g., the host user selecting the Rip option 426 from FIG. 4A). Although FIGS. 4B-4E represent only still images, it should be appreciated that the elements illustrated in FIGS. 4B-4E may animate in various manners, including by moving about the GUI 420, rotating, enlarging, shrinking, etc. The GUI 420 as illustrated in FIGS. 4B-4E may continue to present any of the online session information descried above with respect to FIG. 4A, and/or other suitable information discussed in the present disclosure.

First, in FIG. 4B, the GUI 420 displays an enlarged representation 432 of the bundle 422 from FIG. 4A. Next, in FIG. 4C, a representation of a first item 434 from the bundle 422 is displayed, the representation of the first item 434 including a name of the item and a picture representation of the item. Subsequently, as illustrated in FIG. 4D, the GUI 420 may display a second representation of a second item 436 from the bundle 422, once again including a name and representative image for the second item 436. The GUI 420 may continue to display the representation of the first item 434 from FIG. 4C, but may move the first item 434 to a smaller area of the GUI 420. The GUI 420 may continue to similarly display graphical representations of successive ones of the underlying items in the bundle 422, for example including a third item 438 and fourth item 440 as illustrated in FIG. 4E.

Moving to FIGS. 5A-5E, a client computing device 510 (“guest device”) includes a display 512 (e.g., touchscreen) presenting a GUI 520 that may reveal underlying items in a bundle in a manner similar to that described with respect to the host in FIGS. 4A-4E. The guest device 510 may, for example, be a device of a guest to whom the bundle 422 was awarded, or alternatively may be another guest in the same online session to whom the bundle contents are to be revealed.

Similarly to the GUI 420 in FIG. 4A, the GUI 520 in FIG. 5A may be displayed at the conclusion of the offering of the bundle 422, and may identify the bundle 422 and the guest to whom the bundle 422 is awarded. Similarly to the execution of the GUI 420 in FIGS. 4B-4E, the GUI 520 in FIGS. 5B-5E may animate the revealing of the underlying contents in the bundle 422. In FIG. 5B, the GUI 520 displays the enlarged representation 432 of the bundle 422. In FIG. 5C, the GUI 520 displays the first item 434 in the bundle 422. In FIG. 5D, the GUI 520 displays the first item 434 and the second item 436. The GUI 520 reveals successive items of the bundle 422 until all items are revealed, including for example the third item 438 and fourth item 440 in FIG. 5E.

### Exemplary Computing Device and Server

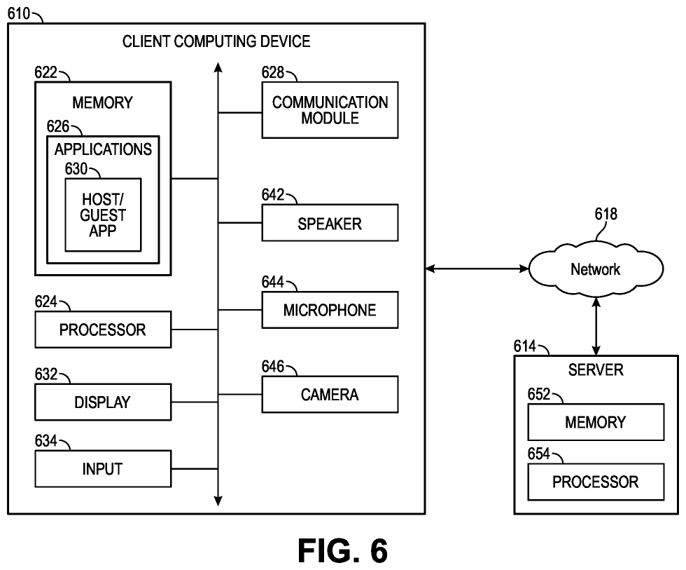

FIG. 6 illustrates a block diagram of example components of a client computing device 610 and one or more servers 614 communicating over a network 618, in accordance with embodiments of the systems and methods described herein. The computing device 610 may correspond, for example, to any of the computing devices of the present disclosure (e.g., the host device 110a, 310, 410, or the guest device 110b, 510). The one or more servers 514 may correspond, for example, to the online session server 124, and/or to another one or more servers (e.g., servers 128, 132, 134, etc.) implementing techniques of the present disclosure. The computing device and/or server 614 may include additional, fewer, or alternate components to those described in this section, in various embodiments. Additionally, in some embodiments, the computing device 610 may be substituted for other computing device(s), e.g., a desktop computer or laptop computer.

The computing device 610 may include a memory 622, which may include one or more non-transitory memories (e.g., ROM) and/or one or more volatile memories (e.g., RAM). In particular, non-transitory portions of the memory 622 may store non-transitory, computer executable instructions that are executable by a processor 624 (i.e., one or more processors) to cause the computing device 610 to perform actions described in the present disclosure. Non-transitory portions of the memory 622 may include one or more applications 626. Each respective application 626 may include one or more sets of non-transitory computer executable instructions that, when executed by the processor 624, cause the computing device 610 to perform operations associated with the respective application 626 (e.g., operations involving the processor 624, a communication module 628, and/or other components of the computing device 610 discussed herein). The one or more applications may include an application 630 (“Host/Guest App”) usable to access online sessions via the online platform of the present disclosure (i.e., as a host of an online session and/or as a guest of an online session).

The computing device 610 may include a display unit 632 (i.e., one or more display devices, such as a touch-enabled visual display (“touchscreen”) or other visual display). The computing device may further include an input unit 634 (i.e., one or more user input devices, e.g., a touchscreen or touchpad, a keyboard, a mouse, etc.). In some embodiments, aspects of the display unit 632 and 634 are integrated (e.g., as a touchscreen with both touch input and display capability). The display unit 632 and/or the input unit 634 may be physically included within the computing device 610 (e.g., a fixedly installed touchscreen), or may be operatively coupled with the computing device 610 by other means (e.g., a peripheral touch pad, mouse, keyboard, etc. connected to the computing device 610 by wired and/or wireless means).

The computing device 610 may include a speaker 642, a microphone 644, and/or a camera 646. In some embodiments, the computing device 610 may include still other sensor components, e.g., a positioning unit (e.g., GPS), an accelerometer, a gyroscope, etc. The speaker 642, microphone 644, camera 646, and/or other sensor component(s) may be physically included within the computing device 610 (e.g., a natively installed speaker, microphone, or camera), and/or may be operatively coupled with the computing device 610 by other means (e.g., a peripheral camera, speaker, or microphone connected to the computing device 610 by wired and/or wireless means).

Collectively, the display unit 632, input unit 634, speaker 642, microphone 644, camera 646, and/or other sensing component(s) may provide one or more user interfaces of the computing device 610. For example, the display unit 632 may display/present one or more graphical user interfaces (GUIs) which may include interactive controls that the user of the computing device 610 can activate via the input device 634 to cause functionalities described herein to be performed (e.g., via a touchscreen tap or swipe, a mouse click, a keyboard stroke, etc.). Additionally or alternatively, in some embodiments, similar user interfaces may be provided at least partially by the speaker 642, microphone 644, camera 646, and/or other sensing components of the computing device 610 (e.g., an interactive audio interface, a gesture-based user interface, or a user interface responsive to physical movement of the computing device 610). In some embodiments, a user of the application 630 at the computing device 610 may configure device permissions defining components of the computing device 610 the application 630 may use to provide GUIs, provide notifications, and/or perform other functionalities of the present disclosure.

The server 614 (i.e., one or more servers, e.g., the online session server 124 and/or other servers of FIG. 1) include a memory 652, which may include one or more non-transitory memories (e.g., ROM) and/or one or more volatile memories (e.g., RAM). In particular, non-transitory portions of the memory 652 may store non-transitory, computer executable instructions that are executable by a processor 654 (i.e., one or more processors) to cause the server 614 to perform actions described in the present disclosure. Non-transitory portions of the memory 652 may include, for example, one or more applications containing non-transitory instructions for controlling logic and communications relating to online sessions, items including bundled items therein, user profiles, device configuration information, analytics, etc. The memory 652 may further include one or more APIs configured to control communications between the server 614 and the computing device 610.

The network 618 may include any suitable one or more communications networks, e.g., the Internet, a wired or wireless local area network (LAN), etc. Communications over the network 618 may include communications according to any suitable one or more communications protocols, including for example a cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of the computing device 610 and/or the server 614.

Various additional and/or alternative computing elements may be envisioned, in various embodiments. In particular, it should be understood that the server 614 may communicate over the network 618 with many computing devices 610, e.g., belonging to various combinations of hosts and/or guests associated with online sessions and/or other aspects of the online platform of the present disclosure.

### Exemplary Computer-Implemented Methods

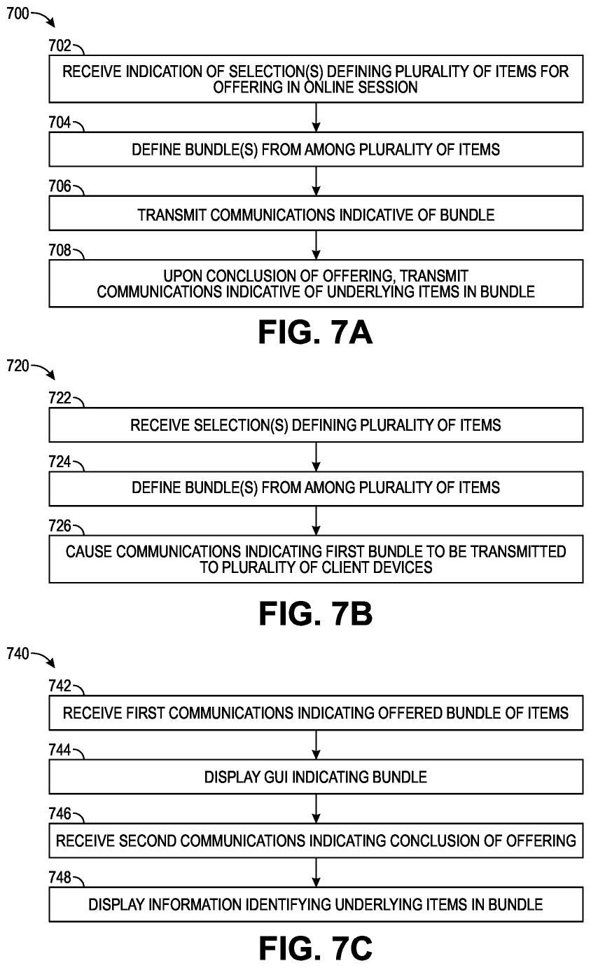

FIGS. 7A-7C illustrate block diagrams of example computer-implemented methods associated with techniques of the present disclosure. Particularly, FIG. 7A relates to a method 700 of one or more servers (e.g., server 124, 618), FIG. 7B relates to a method 720 of a client computing device (e.g., host device 110a, 310, 410, 610), and FIG. 7C relates to another method 740 of a client computing device (e.g., guest device 110b, 510). In embodiments, one or more memories of a device(s) executing methods 700, 720, 740 include non-transitory instructions that, when executed via one or more processors of the device(s), cause the device(s) to perform actions of the methods described herein. Furthermore, in some embodiments, one or more non-transitory computer readable media may be provided (e.g., a non-removable computer memory, a removable flash drive, etc.), the one or more non-transitory computer readable media storing instructions that, when executed by the device(s) herein, cause the device(s) to perform actions of the method(s) herein. Order of actions of the methods 700, 720, 740 may vary from the order illustrated in FIGS. 7A-7C. Moreover, actions of the methods 700, 720, 740 may be combined and/or substituted with other actions described in the present disclosure, in various embodiments.

Beginning with FIG. 7A, the method 700 may include receiving an indication of one or more selections defining a plurality of items (e.g., tangible items and/or digital items such as NFTs) to be offered in an online session (702). Particularly, the indication may be received via a first client computing device associated with a host of the online session (e.g., based upon the host device selecting items to be bundled for offering in an online session). The method 700 further includes defining one or more bundles for the selected plurality of items (702). Each of the one or more bundles defines a respective mutually exclusive subset of the plurality of items, and collectively, the one or more bundles correspond to the selected plurality of items. The method 700 still further includes transmitting first communications to each of a second plurality of client computing devices in the online session, the first communications indicating at least a first bundle among the one or more bundles (706). The first communications, when received at the second plurality of client computing devices, may cause each of the second plurality of client computing devices to display information describing the first bundle without identifying the subset of the plurality of items in the first bundle. Still additionally, the method 700 includes, upon a conclusion of an offering of the first bundle in the online session, transmitting second communications to each of the second plurality of client computing devices in the online session (708). The second communications may cause each of the second plurality of client computing devices to display further information identifying the underlying subset of the plurality of items in the first bundle.

Moving to FIG. 7B, the method 720 may include receiving, via a first graphical user interface, one or more selections defining a plurality of items (e.g., tangible items and/or digital items such as NFTs) to be offered in an online session (722). The method 720 further includes defining one or more bundles for the selected plurality of items (724). Each of the one or more bundles defines a respective mutually exclusive subset of the plurality of items, and the one or more bundles collectively correspond to the selected plurality of items. The method 720 still further includes causing first communications to be transmitted to each of a second plurality of client computing devices in the online session, the first communications indicating at least a first bundle among the one or more bundles (726). The first communications, when received at the second plurality of client computing devices, may cause each of the second plurality of client computing devices to display information describing the first bundle without identifying the underlying subset of the plurality of items in the first bundle.

Moving to FIG. 7C, the method 740 may include receiving, via one or more servers, first communications indicating a first bundle containing one or more items (e.g., tangible items and/or digital items such as NFTs) offered in an online session (742). The method 740 further includes, based upon receiving the first communications, displaying a graphical user interface associated with an offering of the first bundle of items (744). The graphical user interface may display first information associated with the first bundle without identifying the one or more items in the first bundle. The method 740 still further includes receiving second communications via the one or more servers, the second communications indicating a conclusion of the offering of the first bundle (746). Still additionally, the method 740 includes, subsequent to receiving the second communications, displaying, via the graphical user interface, second information associated with the first bundle (748). The second information may identify the one or more underlying items in the first bundle.

The methods 700, 720, 740 may include additional, fewer, and/or alternate actions, in various embodiments, including various actions of the present disclosure.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules. Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as one or more server farms), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or one or more servers farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout the present disclosure, embodiments are described in which various elements are optional—present in some, but not all, embodiments of the system. Where such elements are illustrated in the accompanying figures and, specifically, in figures illustrating block diagrams, the optional elements are generally illustrated in dotted lines to denote their optional nature.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for generating dynamic user experience applications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims. The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

By way of example and not limitation, the present disclosure contemplates at least the following aspects:

A1. A computer-implemented method implemented via one or more processors of one or more servers, the method comprising: receiving an indication of one or more selections defining a plurality of items to be offered in an online session, the indication being received via a first client computing device associated with a host user of the online session; defining one or more bundles for the selected plurality of items, each of the one or more bundles defining a respective mutually exclusive subset of the plurality of items, and the one or more bundles collectively corresponding to the selected plurality of items; transmitting first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and upon a conclusion of an offering of the first bundle in the online session, transmitting second communications to each of the second plurality of client computing devices in the online session, the second communications causing each of the second plurality of client computing devices to display further information identifying the subset of the plurality of items in the first bundle.

A2. The computer-implemented method of aspect A1, wherein the plurality of items comprises a plurality of digital items.

A3. The computer-implemented method of aspect A2, wherein the plurality of digital items comprises a plurality of non-fungible tokens (NFTs).

A4. The computer-implemented method of aspect A3, further comprising: based upon receiving the indication of the one or more selections of the plurality of NFTs, causing the plurality of NFTs to be transferred from a digital wallet of the host user to an intermediary digital wallet; and upon a conclusion of the offering of the first bundle, causing the first bundle of NFTs to be transferred from the intermediary digital wallet to a digital wallet of a guest user to whom the first bundle of NFTs were awarded in the offering of the first bundle.

A5. The computer-implemented method of any one of aspects A1 to A4, wherein the first communications indicating the first bundle include information describing the one or more items in the first bundle but do not identify the subset of the plurality of items in the first bundle.

A6. The computer-implemented method of any one of aspects A1 to A5, wherein the second communications identify the subset of the plurality of items in the first bundle.

A7. The computer-implemented method of any one of aspects A1 to A6, further comprising: subsequent to transmitting the second communications, transmitting third communications to each of the second plurality of client computing devices, the second communications indicating a second bundle among the one or more bundles.

A8. The computer-implemented method of any one of aspects A1 to A7, wherein the transmitting of the first communications is performed responsive to receiving an identification of the first bundle from the first client computing device associated with the host of the online session.

A9. The computer-implemented method of any one of aspects A1 to A8, wherein the second communications cause each of the second plurality of client computing devices in the online session to display an animation revealing the subset of the plurality of items in the first bundle.

A10. The computer-implemented method of any one of aspects A1 to A9, wherein the second plurality of client computing devices includes the first client computing device.

A11. The computer-implemented method of any one of aspects A1 to A10, further comprising: determining one or more price values for each of the one or more bundles, based upon previous sale values associated with the corresponding subsets of items in the one or more bundles, wherein the first communications further indicate the one or more price values for the first bundle.

A12. The computer-implemented method of any one of aspects A1 to A11, in combination with any other one of aspects A1 to A11.

A13. A computing system comprising one or more servers, the one or more servers comprising: one or more processors; and one or more memories storing non-transitory instructions that, when executed via the one or more processors, cause the computing system to: receive an indication of one or more selections defining a plurality of items to be offered in an online session, the indication being received via a first client computing device associated with a host user of the online session; define one or more bundles for the selected plurality of items, each of the one or more bundles defining a respective mutually exclusive subset of the plurality of items, and the one or more bundles collectively corresponding to the selected plurality of items; transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and upon a conclusion of an offering of the first bundle in the online session, transmit second communications to each of the second plurality of client computing devices in the online session, the second communications causing each of the second plurality of client computing devices to display further information identifying the subset of the plurality of items in the first bundle.

A14. The computing system of aspect A13, wherein the plurality of items comprises a plurality of digital items.

A15. The computing system of aspect A14, wherein the plurality of digital items comprises a plurality of non-fungible tokens (NFTs).

A16. The computing system of aspect A15, wherein the non-transitory instructions, when executed via the one or more processors, further cause the computing system to: based upon receiving the indication of the one or more selections of the plurality of NFTs, cause the plurality of NFTs to be transferred from a digital wallet of the host user to an intermediary digital wallet; and upon a conclusion of the offering of the first bundle, cause the first bundle of NFTs to be transferred from the intermediary digital wallet to a digital wallet of a guest user to whom the first bundle of NFTs were awarded in the offering of the first bundle.

A17. The computing system of any one of aspects A13 to A16, wherein the first communications indicating the first bundle include information describing the one or more items in the first bundle but do not identify the subset of the plurality of items in the first bundle.

A18. The computing system of any one of aspects A13 to A17, wherein the second communications identify the subset of the plurality of items in the first bundle.

A19. The computing system of any one of aspects A13 to A18, wherein the non-transitory instructions, when executed via the one or more processors, further cause the computing system to: subsequent to transmitting the second communications, transmit third communications to each of the second plurality of client computing devices, the second communications indicating a second bundle among the one or more bundles.

A20. The computing system of any one of aspects A13 to A19, wherein the transmitting of the first communications is performed responsive to receiving an identification of the first bundle from the first client computing device associated with the host of the online session.

A21. The computing system of any one of aspects A13 to A20, wherein the second communications cause each of the second plurality of client computing devices in the online session to display an animation revealing the subset of the plurality of items in the first bundle.

A22. The computing system of any one of aspects A13 to A21, wherein the second plurality of client computing devices includes the first client computing device.

A23. The computing system of any one of aspects A13 to A22, wherein the non-transitory instructions, when executed via the one or more processors, further cause the computing system to: determine one or more price values for each of the one or more bundles, based upon previous sale values associated with the corresponding subsets of items in the one or more bundles, wherein the first communications further indicate the one or more price values for the first bundle.

A24. The computing system of any one of aspects A13 to A23, in combination with any other one of aspects A13 to A23.

A25. One or more computer readable media storing non-transitory instructions that, when executed via one or more processors of one or more computers, cause the one or more computers to: receive an indication of one or more selections defining a plurality of items to be offered in an online session, the indication being received via a first client computing device associated with a host user of the online session; define one or more bundles for the selected plurality of items, each of the one or more bundles defining a respective mutually exclusive subset of the plurality of items, and the one or more bundles collectively corresponding to the selected plurality of items; transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and upon a conclusion of an offering of the first bundle in the online session, transmit second communications to each of the second plurality of client computing devices in the online session, the second communications causing each of the second plurality of client computing devices to display further information identifying the subset of the plurality of items in the first bundle.

A26. The one or more computer readable media of aspect A25, wherein the plurality of items comprises a plurality of digital items.

A27. The one or more computer readable media of aspect A26, wherein the plurality of digital items comprises a plurality of non-fungible tokens (NFTs).

A28. The one or more computer readable media of aspect A27, wherein the non-transitory instructions, when executed via the one or more processors, further cause the one or more computers to: based upon receiving the indication of the one or more selections of the plurality of NFTs, cause the plurality of NFTs to be transferred from a digital wallet of the host user to an intermediary digital wallet; and upon a conclusion of the offering of the first bundle, cause the first bundle of NFTs to be transferred from the intermediary digital wallet to a digital wallet of a guest user to whom the first bundle of NFTs were awarded in the offering of the first bundle.

A29. The one or more computer readable media of any one of aspects A25 to A28, wherein the first communications indicating the first bundle include information describing the one or more items in the first bundle but do not identify the subset of the plurality of items in the first bundle.

A30. The one or more computer readable media of any one of aspects A25 to A29, wherein the second communications identify the subset of the plurality of items in the first bundle.

A31. The one or more computer readable media of any one of aspects A25 to A30, wherein the non-transitory instructions, when executed via the one or more processors, further cause the one or more computers to: subsequent to transmitting the second communications, transmit third communications to each of the second plurality of client computing devices, the second communications indicating a second bundle among the one or more bundles.

A32. The one or more computer readable media of any one of aspects A25 to A31, wherein the transmitting of the first communications is performed responsive to receiving an identification of the first bundle from the first client computing device associated with the host of the online session.

A33. The one or more computer readable media of any one of aspects A25 to A32, wherein the second communications cause each of the second plurality of client computing devices in the online session to display an animation revealing the subset of the plurality of items in the first bundle.

A34. The one or more computer readable media of any one of aspects A25 to A33, wherein the second plurality of client computing devices includes the first client computing device.

A35. The one or more computer readable media of any one of aspects A25 to A34, wherein the non-transitory instructions, when executed via the one or more processors, further cause the one or more computers to: determine one or more price values for each of the one or more bundles, based upon previous sale values associated with the corresponding subsets of items in the one or more bundles, wherein the first communications further indicate the one or more price values for the first bundle.

A36. The one or more computer readable media of any one of aspects A25 to A35, in combination with any other one of aspects A25 to A35.

A37. Any one of aspects A1 to A36, in combination with any other suitable one of aspects A1 to A36.

B1. A computer-implemented method implemented via one or more processors of a first client computing device, the method comprising: receiving, via a first graphical user interface, one or more selections defining a plurality of items to be offered in an online session; defining one or more bundles for the selected plurality of items, each of the one or more bundles defining a respective mutually exclusive subset of the plurality of items, and the one or more bundles collectively corresponding to the selected plurality of items; and causing first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle.

B2. The computer-implemented method of aspect B1, wherein the plurality of items comprises a plurality of digital items.

B3. The computer-implemented method of aspect B1 or B2, wherein the plurality of digital items comprises a plurality of non-fungible tokens (NFTs).

B4. The computer-implemented method of any one of aspects B1 to B3, wherein the first communications indicating the first bundle include information describing the subset of the plurality of items in the first bundle but do not identify the subset of the plurality of items in the first bundle.

B5. The computer-implemented method of any one of aspects B1 to B4, further comprising, upon a conclusion of an offering of the first bundle in the online session, causing second communications to be transmitted each of the second plurality of client computing devices in the online session, the second communications causing each of the second plurality of client computing devices to display further information identifying the subset of the plurality of items in the first bundle.

B6. The computer-implemented method of aspect B5, wherein the second communications identify the subset of the plurality of items in the first bundle.

B7. The computer-implemented method of aspect B5 or B6, wherein the second communications cause each of the second plurality of client computing devices in the online session to display an animation revealing the one or more items in the first bundle.

B8. The computer-implemented method of any one of aspects B5 to B7, further comprising, subsequent to causing the second communications to be transmitted, causing third communications to be transmitted to each of the second plurality of client computing devices, the third communications indicating a second bundle among the one or more bundles to be offered in the online session.

B9. The computer-implemented method of any one of aspects B1 to B8, wherein the causing of the first communications to be transmitted is performed in response to receiving, via a graphical user interface of the online session, a selection of the first bundle to be offered in the online session.

B10. The computer-implemented method of any one of aspects B1 to B9, in combination with any other one of aspects B1 to B9.

B11. One or more computer readable media storing non-transitory instructions that, when executed via one or more processors of a first client computing device, cause the first client computing device to: receive, via a first graphical user interface, one or more selections defining a plurality of items to be offered in an online session; define one or more bundles for the selected plurality of items, each of the one or more bundles defining a respective mutually exclusive subset of the plurality of items, and the one or more bundles collectively corresponding to the selected plurality of items; and cause first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle.

B12. The one or more computer readable media of aspect B11, wherein the plurality of items comprises a plurality of digital items.

B13. The one or more computer readable media of aspect B11 or B12, wherein the plurality of digital items comprises a plurality of non-fungible tokens (NFTs).

B14. The one or more computer readable media of any one of aspects B11 to B13, wherein the first communications indicating the first bundle include information describing the subset of the plurality of items in the first bundle but do not identify the subset of the plurality of items in the first bundle.

B15. The one or more computer readable media of any one of aspects B11 to B14, wherein the non-transitory instructions, when executed via the one or more processors, further cause the first client computing device to: upon a conclusion of an offering of the first bundle in the online session, cause second communications to be transmitted each of the second plurality of client computing devices in the online session, the second communications causing each of the second plurality of client computing devices to display further information identifying the subset of the plurality of items in the first bundle.

B116. The one or more computer readable media of aspect B15, wherein the second communications identify the subset of the plurality of items in the first bundle.

B17. The one or more computer readable media of aspect B15 or B16, wherein the second communications cause each of the second plurality of client computing devices in the online session to display an animation revealing the one or more items in the first bundle.

B18. The one or more computer readable media of any one of aspects B15 to B17, wherein the non-transitory instructions, when executed via the one or more processors, further cause the first client computing device to: subsequent to causing the second communications to be transmitted, cause third communications to be transmitted to each of the second plurality of client computing devices, the third communications indicating a second bundle among the one or more bundles to be offered in the online session.

B19. The one or more computer readable media of any one of aspects B11 to B18, wherein the causing of the first communications to be transmitted is performed in response to receiving, via a graphical user interface of the online session, a selection of the first bundle to be offered in the online session.

B20. The one or more computer readable media of any one of aspects B11 to B19, in combination with any other one of aspects B11 to B19.

B21. A first client computing device comprising: one or more processors; and one or more memories storing non-transitory instructions that, when executed via the one or more processors, cause the first client computing device to: receive, via a first graphical user interface, one or more selections defining a plurality of items to be offered in an online session; define one or more bundles for the selected plurality of items, each of the one or more bundles defining a respective mutually exclusive subset of the plurality of items, and the one or more bundles collectively corresponding to the selected plurality of items; and cause first communications to be transmitted to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle.

B22. The first client computing device of aspect B21, wherein the plurality of items comprises a plurality of digital items.

B23. The first client computing device of aspect B21 or B22, wherein the plurality of digital items comprises a plurality of non-fungible tokens (NFTs).

B24. The first client computing device of any one of aspects B21 to B23, wherein the first communications indicating the first bundle include information describing the subset of the plurality of items in the first bundle but do not identify the subset of the plurality of items in the first bundle.

B25. The first client computing device of any one of aspects B21 to B24, wherein the non-transitory instructions, when executed via the one or more processors, further cause the first client computing device to: upon a conclusion of an offering of the first bundle in the online session, cause second communications to be transmitted each of the second plurality of client computing devices in the online session, the second communications causing each of the second plurality of client computing devices to display further information identifying the subset of the plurality of items in the first bundle.

B26. The first client computing device of aspect B25, wherein the second communications identify the subset of the plurality of items in the first bundle.

B27. The first client computing device of aspect B25 or B26, wherein the second communications cause each of the second plurality of client computing devices in the online session to display an animation revealing the one or more items in the first bundle.

B28. The first client computing device of any one of aspects B25 to B27, wherein the non-transitory instructions, when executed via the one or more processors, further cause the first client computing device to: subsequent to causing the second communications to be transmitted, cause third communications to be transmitted to each of the second plurality of client computing devices, the third communications indicating a second bundle among the one or more bundles to be offered in the online session.

B29. The first client computing device of any one of aspects B21 to B28, wherein the causing of the first communications to be transmitted is performed in response to receiving, via a graphical user interface of the online session, a selection of the first bundle to be offered in the online session

B30. The first client computing device of any one of aspects B21 to B29, in combination with any other one of aspects B21 to B29.

B31. Any one of aspects B1 to B30, in combination with any other suitable one of aspects B1 to B30.

C1. A computer-implemented method implemented via one or more processors of a client computing device, the method comprising: receiving, via one or more servers, first communications indicating a first bundle containing one or more items offered in an online session; based upon receiving the first communications, displaying a graphical user interface associated with an offering of the first bundle of items, the graphical user interface displaying first information associated with the first bundle without identifying the one or more items in the first bundle; receiving second communications via the one or more servers, the second communications indicating a conclusion of the offering of the first bundle; and subsequent to receiving the second communications, displaying, via the graphical user interface, second information associated with the first bundle, the second information identifying the one or more items in the first bundle.

C2. The computer-implemented method of aspect C1, wherein the plurality of items comprises a plurality of digital items.

C3. The computer-implemented method of aspect C1 or C2, wherein the plurality of digital items comprises a plurality of non-fungible tokens (NFTs).

C4. The computer-implemented method of any one of aspects C1 to C3, wherein the first communications indicating the first bundle include information describing the one or more items in the first bundle but do not identify the one or more items in the first bundle.

C5. The computer-implemented method of any one of aspects C1 to C4, wherein the second communications identify the one or more items in the first bundle.

C6. The computer-implemented method of any one of aspects C1 to C5, wherein the displaying of the second information associated with the first bundle is performed in response to receiving the second communications.

C7. The computer-implemented method of any one of aspects C1 to C6, wherein the displaying of the second information associated with the first bundle is performed subsequent to receiving the second communications and in response to receiving a selection via the graphical user interface to reveal the one or more items in the first bundle.

C8. The computer-implemented method of any one of aspects C1 to C7, further comprising, subsequent to displaying the second information associated with the first bundle: receiving, via the one or more servers, third communications indicating a second bundle containing a further one or more items offered in an online session; and based upon receiving the third communications, displaying, via the graphical user interface, third information associated with the second bundle without identifying the further one or more items in the second bundle.

C9. The computer-implemented method of any one of aspects C1 to C8, further comprising: receiving, via the graphical user interface, one or more user interactions indicative of an attempt to obtain the first offered bundle on behalf of a user of the client computing device; and transmitting, to the one or more servers, additional communications indicating the attempt to obtain the first offered bundle, and wherein the second communications identify the user of the client computing device as having obtained the first bundle.

C10. The computer-implemented method of any one of aspects C1 to C9, in combination with any other one of aspects C1 to C9.

C11. One or more computer readable media storing non-transitory instructions that, when executed via one or more processors of a client computing device, cause the client computing device to: receive, via one or more servers, first communications indicating a first bundle containing one or more items offered in an online session; based upon receiving the first communications, display a graphical user interface associated with an offering of the first bundle of items, the graphical user interface displaying first information associated with the first bundle without identifying the one or more items in the first bundle; receive second communications via the one or more servers, the second communications indicating a conclusion of the offering of the first bundle; and subsequent to receiving the second communications, display, via the graphical user interface, second information associated with the first bundle, the second information identifying the one or more items in the first bundle.

C12. The one or more computer readable media of aspect C11, wherein the plurality of items comprises a plurality of digital items.

C13. The one or more computer readable media of aspect C11, or C12, wherein the plurality of digital items comprises a plurality of non-fungible tokens (NFTs).

C14. The one or more computer readable media of any one of aspects C11 to C13, wherein the first communications indicating the first bundle include information describing the one or more items in the first bundle but do not identify the one or more items in the first bundle.

C15. The one or more computer readable media of any one of aspects C11 to C14, wherein the second communications identify the one or more items in the first bundle.

C16. The one or more computer readable media of any one of aspects C11 to C15, wherein the displaying of the second information associated with the first bundle is performed in response to receiving the second communications.

C17. The one or more computer readable media of any one of aspects C11 to C16, wherein the displaying of the second information associated with the first bundle is performed subsequent to receiving the second communications and in response to receiving a selection via the graphical user interface to reveal the one or more items in the first bundle.

C18. The one or more computer readable media of any one of aspects C11 to C17, wherein the non-transitory instructions, when executed via the one or more processors, further cause the client computing device to, subsequent to displaying the second information associated with the first bundle: receive, via the one or more servers, third communications indicating a second bundle containing a further one or more items offered in an online session; and based upon receiving the third communications, display, via the graphical user interface, third information associated with the second bundle without identifying the further one or more items in the second bundle.

C19. The one or more computer readable media of any one of aspects C11 to C18, wherein the non-transitory instructions, when executed via the one or more processors, further cause the client computing device to: receive, via the graphical user interface, one or more user interactions indicative of an attempt to obtain the first offered bundle on behalf of a user of the client computing device; and transmit, to the one or more servers, additional communications indicating the attempt to obtain the first offered bundle, wherein the second communications identify the user of the client computing device as having obtained the first bundle.

C20. The one or more computer readable media of any one of aspects C11 to C19, in combination with any other one of aspects C11 to C19.

C21. A client computing device comprising: one or more processors; and one or more memories storing non-transitory instructions that, when executed via the one or more processors, cause the client computing device to: receive, via one or more servers, first communications indicating a first bundle containing one or more items offered in an online session; based upon receiving the first communications, display a graphical user interface associated with an offering of the first bundle of items, the graphical user interface displaying first information associated with the first bundle without identifying the one or more items in the first bundle; receive second communications via the one or more servers, the second communications indicating a conclusion of the offering of the first bundle; and subsequent to receiving the second communications, display, via the graphical user interface, second information associated with the first bundle, the second information identifying the one or more items in the first bundle.

C22. The client computing device of aspect C21, wherein the plurality of items comprises a plurality of digital items.

C23. The client computing device of aspect C21 or C22, wherein the plurality of digital items comprises a plurality of non-fungible tokens (NFTs).

C24. The client computing device of any one of aspects C21 to C23, wherein the first communications indicating the first bundle include information describing the one or more items in the first bundle but do not identify the one or more items in the first bundle.

C25. The client computing device of any one of aspects C21 to C24, wherein the second communications identify the one or more items in the first bundle.

C26. The client computing device of any one of aspects C21 to C25, wherein the displaying of the second information associated with the first bundle is performed in response to receiving the second communications.

C27. The client computing device of any one of aspects C21 to C26, wherein the displaying of the second information associated with the first bundle is performed subsequent to receiving the second communications and in response to receiving a selection via the graphical user interface to reveal the one or more items in the first bundle.

C28. The client computing device of any one of aspects C21 to C27, wherein the non-transitory instructions, when executed via the one or more processors, further cause the client computing device to, subsequent to displaying the second information associated with the first bundle: receive, via the one or more servers, third communications indicating a second bundle containing a further one or more items offered in an online session; and based upon receiving the third communications, display, via the graphical user interface, third information associated with the second bundle without identifying the further one or more items in the second bundle.

C29. The client computing device of any one of aspects C21 to C28, wherein the non-transitory instructions, when executed via the one or more processors, further cause the client computing device to: receive, via the graphical user interface, one or more user interactions indicative of an attempt to obtain the first offered bundle on behalf of a user of the client computing device; and transmit, to the one or more servers, additional communications indicating the attempt to obtain the first offered bundle, wherein the second communications identify the user of the client computing device as having obtained the first bundle.

C30. The client computing device of any one of aspects C21 to C29, in combination with any other one of aspects C21 to C29.

C31. Any one of aspects C1 to C30, in combination with any other suitable one of aspects C1 to C30.

D1. Any one of aspects A1 to A37, B1 to B31, or C1 to C31, in combination with any other one of aspects A1 to A37, B1 to B31, or C1 to C31.

What is claimed is:

1. A computer-implemented method implemented via one or more processors of one or more servers, the method comprising:
receiving an indication of one or more selections defining a plurality of items to be offered in an online session, the indication being received via a first client computing device associated with a host user of the online session;
defining one or more bundles for the selected plurality of items, each of the one or more bundles defining a respective mutually exclusive subset of the plurality of items, and the one or more bundles collectively corresponding to the selected plurality of items;
transmitting first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and
upon a conclusion of an offering of the first bundle in the online session, transmitting second communications to each of the second plurality of client computing devices in the online session, the second communications causing each of the second plurality of client computing devices to display further information identifying the subset of the plurality of items in the first bundle.

2. The computer-implemented method of claim 1, wherein the plurality of items comprises a plurality of non-fungible tokens (NFTs).

3. The computer-implemented method of claim 2, further comprising:
based upon receiving the indication of the one or more selections of the plurality of NFTs, causing the plurality of NFTs to be transferred from a digital wallet of the host user to an intermediary digital wallet; and
upon a conclusion of the offering of the first bundle, causing the first bundle of NFTs to be transferred from the intermediary digital wallet to a digital wallet of a guest user to whom the first bundle of NFTs were awarded in the offering of the first bundle.

4. The computer-implemented method claim 1, wherein the first communications indicating the first bundle include information describing the one or more items in the first bundle but do not identify the subset of the plurality of items in the first bundle.

5. The computer-implemented method of claim 1, wherein the second communications identify the subset of the plurality of items in the first bundle.

6. The computer-implemented method of claim 1, further comprising:
subsequent to transmitting the second communications, transmitting third communications to each of the second plurality of client computing devices, the second communications indicating a second bundle among the one or more bundles.

7. The computer-implemented method of claim 1, wherein the transmitting of the first communications is performed responsive to receiving an identification of the first bundle from the first client computing device associated with the host of the online session.

8. The computer-implemented method of claim 1, wherein the second communications cause each of the second plurality of client computing devices in the online session to display an animation revealing the subset of the plurality of items in the first bundle.

9. The computer-implemented method of claim 1 wherein the second plurality of client computing devices includes the first client computing device.

10. The computer-implemented method of claim 1, further comprising:
determining one or more price values for each of the one or more bundles, based upon previous sale values associated with the corresponding subsets of items in the one or more bundles,
wherein the first communications further indicate the one or more price values for the first bundle.

11. A computing system comprising one or more servers, the one or more servers comprising:
one or more processors; and
one or more memories storing non-transitory instructions that, when executed via the one or more processors, cause the computing system to:
receive an indication of one or more selections defining a plurality of items to be offered in an online session, the indication being received via a first client computing device associated with a host user of the online session;
define one or more bundles for the selected plurality of items, each of the one or more bundles defining a respective mutually exclusive subset of the plurality of items, and the one or more bundles collectively corresponding to the selected plurality of items;
transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and
upon a conclusion of an offering of the first bundle in the online session, transmit second communications to each of the second plurality of client computing devices in the online session, the second communications causing each of the second plurality of client computing devices to display further information identifying the subset of the plurality of items in the first bundle.

12. The computing system of claim 11, wherein the plurality of items comprises a plurality of non-fungible tokens (NFTs).

13. The computing system of claim 12, wherein the non-transitory instructions, when executed via the one or more processors, further cause the computing system to:
based upon receiving the indication of the one or more selections of the plurality of NFTs, cause the plurality of NFTs to be transferred from a digital wallet of the host user to an intermediary digital wallet; and
upon a conclusion of the offering of the first bundle, cause the first bundle of NFTs to be transferred from the intermediary digital wallet to a digital wallet of a guest user to whom the first bundle of NFTs were awarded in the offering of the first bundle.

14. The computing system of claim 11, wherein the first communications indicating the first bundle include information describing the one or more items in the first bundle but do not identify the subset of the plurality of items in the first bundle.

15. The computing system of claim 11, wherein the second communications identify the subset of the plurality of items in the first bundle.

16. The computing system of claim 11, wherein the non-transitory instructions, when executed via the one or more processors, further cause the computing system to:
subsequent to transmitting the second communications, transmit third communications to each of the second plurality of client computing devices, the second communications indicating a second bundle among the one or more bundles.

17. The computing system of claim 11, wherein the transmitting of the first communications is performed responsive to receiving an identification of the first bundle from the first client computing device associated with the host of the online session.

18. The computing system of claim 11, wherein the second communications cause each of the second plurality of client computing devices in the online session to display an animation revealing the subset of the plurality of items in the first bundle.

19. The computing system of claim 11, wherein the second plurality of client computing devices includes the first client computing device.

20. The computing system of claim 11, wherein the non-transitory instructions, when executed via the one or more processors, further cause the computing system to:
determine one or more price values for each of the one or more bundles, based upon previous sale values associated with the corresponding subsets of items in the one or more bundles,
wherein the first communications further indicate the one or more price values for the first bundle.

21. One or more computer readable media storing non-transitory instructions that, when executed via one or more processors of one or more computers, cause the one or more computers to:
receive an indication of one or more selections defining a plurality of items to be offered in an online session, the indication being received via a first client computing device associated with a host user of the online session;
define one or more bundles for the selected plurality of items, each of the one or more bundles defining a respective mutually exclusive subset of the plurality of items, and the one or more bundles collectively corresponding to the selected plurality of items;
transmit first communications to each of a second plurality of client computing devices in the online session, the first communications indicating at least a first bundle among the one or more bundles, and the first communications causing each of the second plurality of client computing devices to display information describing the first bundle without identifying the subset of the plurality of items in the first bundle; and
upon a conclusion of an offering of the first bundle in the online session, transmit second communications to each of the second plurality of client computing devices in the online session, the second communications causing each of the second plurality of client computing devices to display further information identifying the subset of the plurality of items in the first bundle.

22. The one or more computer readable media of claim 21, wherein the plurality of items comprises a plurality of non-fungible tokens (NFTs).

23. The one or more computer readable media of claim 22, wherein the non-transitory instructions, when executed via the one or more processors, further cause the one or more computers to:
based upon receiving the indication of the one or more selections of the plurality of NFTs, cause the plurality of NFTs to be transferred from a digital wallet of the host user to an intermediary digital wallet; and
upon a conclusion of the offering of the first bundle, cause the first bundle of NFTs to be transferred from the intermediary digital wallet to a digital wallet of a guest user to whom the first bundle of NFTs were awarded in the offering of the first bundle.

24. The one or more computer readable media of claim 21, wherein the first communications indicating the first bundle include information describing the one or more items in the first bundle but do not identify the subset of the plurality of items in the first bundle.

25. The one or more computer readable media of claim 21, wherein the second communications identify the subset of the plurality of items in the first bundle.

26. The one or more computer readable media of claim 21, wherein the non-transitory instructions, when executed via the one or more processors, further cause the one or more computers to:
subsequent to transmitting the second communications, transmit third communications to each of the second plurality of client computing devices, the second communications indicating a second bundle among the one or more bundles.

27. The one or more computer readable media of claim 21, wherein the transmitting of the first communications is performed responsive to receiving an identification of the first bundle from the first client computing device associated with the host of the online session.

28. The one or more computer readable media of claim 21, wherein the second communications cause each of the second plurality of client computing devices in the online session to display an animation revealing the subset of the plurality of items in the first bundle.

29. The one or more computer readable media of claim 21, wherein the second plurality of client computing devices includes the first client computing device.

30. The one or more computer readable media of claim 21, wherein the non-transitory instructions, when executed via the one or more processors, further cause the one or more computers to:
determine one or more price values for each of the one or more bundles, based upon previous sale values associated with the corresponding subsets of items in the one or more bundles,
wherein the first communications further indicate the one or more price values for the first bundle.
